(19) United States
(12) Patent Application Publication
(10) Pub. No.: US 2012/0119515 A1
(43) Pub. Date: May 17, 2012

(54) SYSTEM FOR RECOVERING ENERGY IN APPARATUSES FOR THE HANDLING OF LOADS

(76) Inventor: Fulvio Soldaini, Vaglia (FI) (IT)

(21) Appl. No.: 13/386,254

(22) PCT Filed: Jul. 20, 2010
(86) PCT No.: PCT/IT2010/000320

§ 371 Date: Jan. 20, 2012

(51) Int. Cl. H02K 7/18

(52) U.S. Cl. 290/1 R

(57) ABSTRACT

System for recovering energy in apparatuses for handling loads wherein a load (2) is vertically moved by means of motor means (M) that, in relation to the operative state thereof, absorbs electric energy in a greater or smaller quantity that a preset value. The system comprises sensing means of the energy instant-by-instant absorbed by the said motor means (M), at least one electric energy generator (G) apt to transform into electric energy the rotation of a shaft (6m) presented by the said motor (M). The sensing means operate the activation of said at least one generator (G) when the energy absorbed by the motor (M) is less than a preset value and operate the deactivation of the said at least one generator (G) when the energy absorbed by the motor (M) is greater than the preset value.

The present invention relates to a system for recovering energy in apparatuses for the handling of loads such as lifts, goods hoists and similar apparatuses, or lifting apparatuses such as cranes. Apparatuses such as lifts and goods hoists usually foresee a cabin or a room destined to the transport of a load, a counter-load connected to the cabin or to the room by means of a cable passing around a pulley and a motor which is kinematically connected to the pulley to move it into rotation. In practice, to limit the energy consumption of the motor, the latter is made to work under such conditions that the necessary work (without considering the various losses due to the transformation of motion into friction and so on) does not correspond to the whole weight of the cabin and of the content thereof but to the difference between the value of the cabin weight and its corresponding counter-load

In case the value of the cabin weight and of the content thereof is higher than the value of the counter-load, the motor will consume more energy in the ascent motion (of the cabin). Under the same load conditions, in the corresponding descent run, the work of the motor is substantially replaced by the weight force exerted by the cabin.

On the contrary, when the value of the cabin weight and of the content thereof is lower than the value of the counter-load, the motor will consume more energy in the descent motion. Under these load conditions, the work of the motor will substantially be replaced by the weight force exerted by the counter-load in the ascent run of cabin.

The aim of the present invention is to recover energy, in particular when the operative conditions of the motor are advantageous with respect to the energy requirements; in practice, with reference to lifting apparatuses such as lifts, goods hoists with a counter-load, in the ascent runs of the cabin, when the value of the weight of the latter (including the load thereof) is lower than the value of the counter-load and, in the descent runs of the cabin, when the value of the weight of the latter (including the load thereof) is higher than the value of the counter-load Analogously, in case of lifting apparatuses without a counter-load, the energy is recovered thanks to the gravity acting on the load in the descent phases.

These results have been achieved, according to the invention, by adopting the idea of providing a system having the features described in claim 1. Further features of the invention are the subject of the dependent claims.

Among the advantages of the present invention are those described in the following:
the energy is recovered with a relatively high efficiency. thanks to the use of apparatuses expressly dedicated to the scope they are destined to;
the system can be applied in newly constructed lifting apparatuses, but it can also be employed for the requalification of already existing apparatuses (“retrofit) including lifting apparatuses such as cranes and similar apparatuses;
the system has a rather reduced additional cost in comparison with traditional systems and its cost is rapidly amortized thanks to the use of the system in terms of energy savings;
the requirements of the lifting apparatus for an inferior amount of energy offer advantages from the point of view of consumption, of energy savings in general with positive effects on the environment;
its structure is solid and allows its peculiar features to remain unaltered in the course of time, even after an extremely prolonged use.

Each technician who works in this field will better understand these features and further features and advantages of the present invention thanks to the following description and to the enclosed drawings given as a practical explanation of the present invention which should not, be seen in a limitative sense, wherein:

FIG. 1 is a diagram concerning a possible embodiment of a system according to the invention;

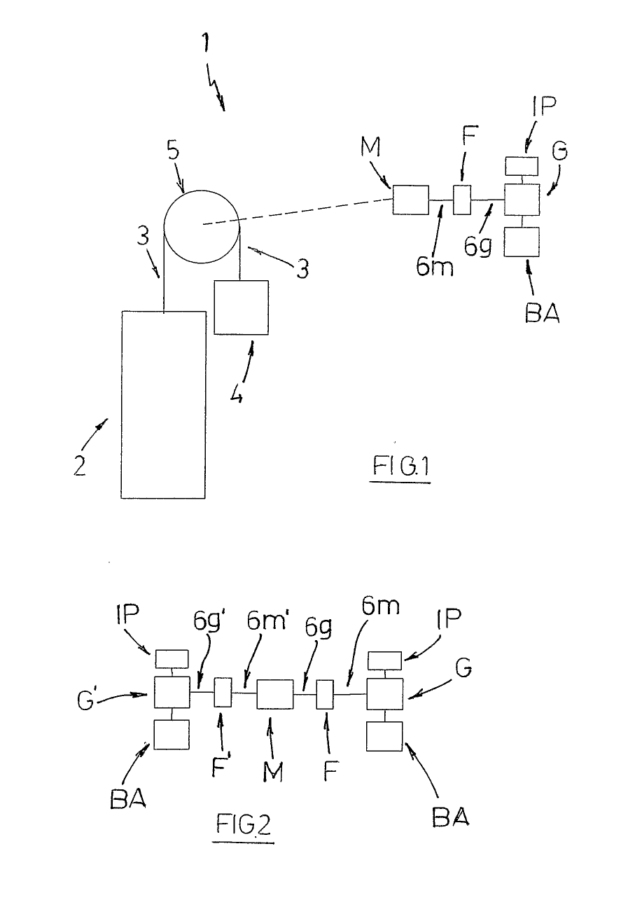

FIG. 2 is a diagram concerning another embodiment of the invention;

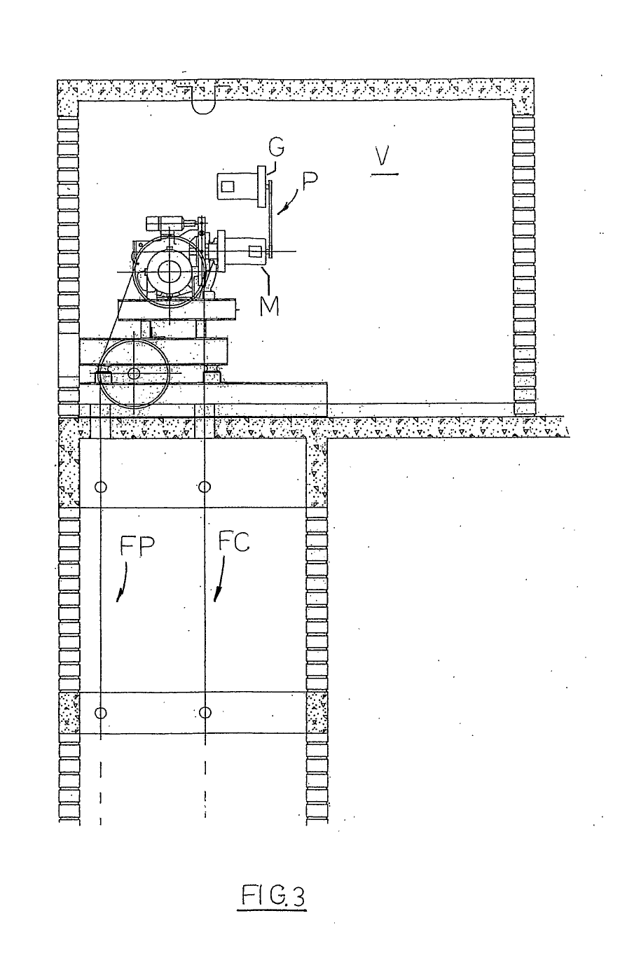

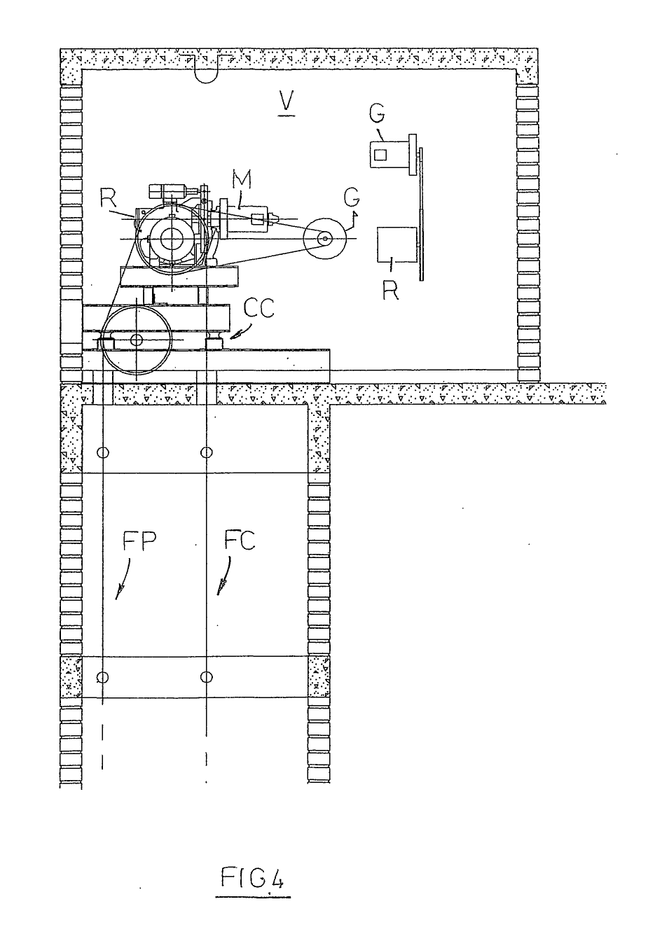

FIGS. 3-5 show further embodiments of a system according to the invention;

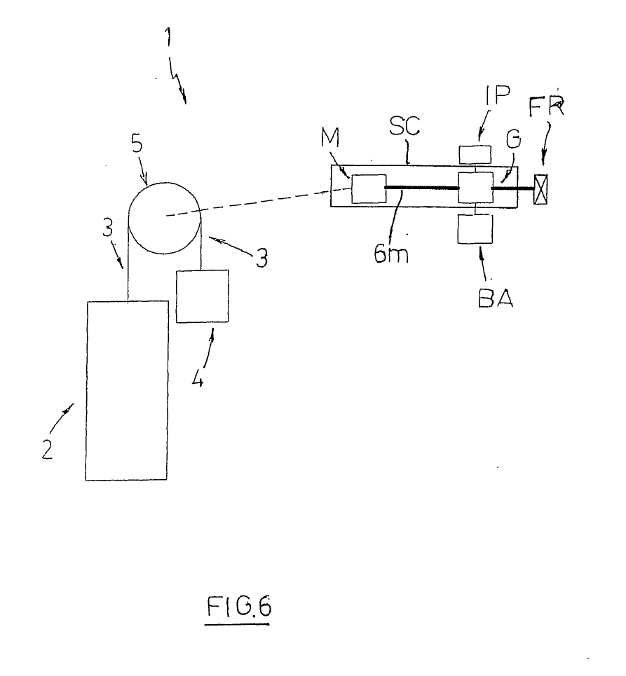

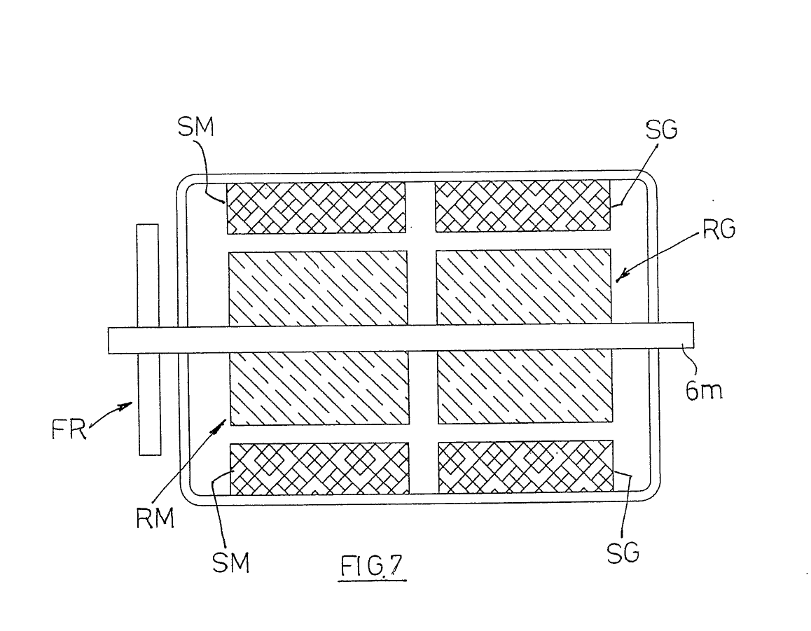

FIGS. 6 and 7 show yet another embodiment of a system according to the invention.

With reference to the FIGS. 1 and 2 of the enclosed drawings, a system for recovering energy according to the invention can be used in cooperation with a lifting apparatus, schematically represented by a lift in the drawings.

The lifting apparatus comprises a cabin (2) destined to contain the load to be vertically moved.

The cabin (2) is connected to a counter-load (4) by means of a cable (3) passing around a pulley (5). In a well-known manner, the lifting of the cabin (2) corresponds to the lowering of the counterweight (4) and vice versa.

In its vertical bidirectional movement, the cabin (2) is driven along vertical tracks, which are not shown; analogously, other details which are not strictly connected with the invention, are not shown in the drawings and/or mentioned in the present description.

A motor (M) which allows the shaft of the pulley (5) to rotate in one direction or in the other direction according to the descent or ascent movement of the cabin (2), acts on the pulley (5).

The motor (M) drives a corresponding shaft (6m), to which a generator (G), apt to transform into electric energy the rotation of an output shaft (6m) is connected; in the output, the generator (G) is connected to a preset amount of batteries (B). Connecting means or a clutch (F) which, on command, connect the shaft (6m) of the motor (M) to the shaft (6g) on which the generator acts directly, are disposed between the motor (M) and the generator (G).

The function of the clutch (F) is to connect the shaft (6m) of the motor (M) to the shaft (6g) of the generator (G) only when it is necessary to store energy deriving from “positive work” due to the force of gravity.

The clutch (F) is advantageously an electric clutch, that is to say connecting means which can be electrically activated, automatically with the detection of a preset threshold value in the energy absorption of the motor (M) In practice, the connecting means (F) connect the two shafts (6m) and (6g) when the motor (M) does not absorb energy. An electronic or mechanical change pole switch (IP) associated with a generator (G) is foreseen to allow the charging of batteries, independently of the direction of rotation of the shaft (6g).

During functioning of the system described above, it is possible to hypotise the following configurations:

a. weight of the cabin (2) (and of the carried load) inferior to the weight of the counter-load (4);
b. weight of the cabin (2) (and of the carried load) greater than the weight of the counter-load (4);
c. weight of the cabin (2) (and of the carried load) equal to the weight of the counter-load (4).

In the case a (weight of the cabin<weight of the counter-load), when the cabin is moved upwards, the motor (M) does not require energy, since the thrust upwards of the cabin (2) is determined by the force of gravity acting on the counter-load (4). In this case, the connecting means (F) connect the generator (O) to the shaft of the motor (M), and allow the mechanical energy of the shaft to be transformed into electric energy stored in the battery (B) so that it can be used in the desired manner. On the contrary, when the cabin is moved downwards, (descent) the motor (M) has to provide energy to overcome the weight force of the counter-load (4) which, as already said, has a higher value with respect to the cabin (2). In this case, the connecting means do not intervene, and the two shafts (6m) and (6g) remain disconnected.

In case b (weight of the cabin>weight of the counter-load), when the cabin is moved downwards, the motor (M) does not require energy since the descent of the cabin (2) is determined by the force of gravity acting on the cabin (2) which has a greater weight that the counter-load (4). In this case, the connecting means (F) connect the generator (G) to the shaft of the motor (M) and allow the mechanical energy of the shaft to be transformed into electric energy and to be stored in the battery (B) On the contrary, when the cabin is moved upward (ascent), the motor (M) has to provide energy to overcome the weight force of the cabin (2) and of its content. In this case, the connecting means (F) do not intervene and the two shafts (6m) and (6g) remain disconnected

In case c, the motor (M) has very reduced energy requirements to overcome the resistances offered by the various frictions. The above mentioned “positive work”, however, cannot be obtained, therefore the connecting means (F) leave the two shafts (6m) and (6g) disconnected.

For example, to determine if the clutch has to connect the shafts (6m) and (6g) or not, it is possible to detect the intensity of the current absorbed by the motor (M) and to compare it to the preset threshold value, so as to determine the connection between the said shafts only if the current absorbed by the motor (M) is inferior to the preset threshold value. Contextually, it is possible to detect, that is to say to control the direction of rotation of the shaft (6m).

FIG. 2 shows another possible embodiment of the invention, in which the generators (G, G′) are in a number greater than one. In this case, the generators are two in number and they are mounted on two shafts (6g,6g′) connectable to two corresponding shafts (6m,6m′) presented by the motor (M), on two opposite sides.

In both possible embodiments described above, the advantages deriving from the use of “dedicated” apparatuses are evident; in practice, the motor (M) is used to transform electric energy into mechanical energy by rotating the shaft of the pulley (5) and the generator, generators (G, G′) is/are used to transform the mechanical energy of the rotation of the shaft (6g,6g′) into electric energy to be accumulated in the battery (BA). In this way, the function of motor means is performed by the motor (M) which performs also the function of a generator, therefore, the motor and the generator (or the generators) can be chosen each with the most suitable features (also in terms of performances and efficiency) in relation to the function to be performed and, for this reason, the whole efficiency of the system is higher than that of the systems in which the motor is also used as a generator.

In the case of lifting apparatuses without a counter-load, the connection between the shaft of the motor and the shaft of the generator is effected only in the descent phases of the load

From the previous description, moreover, it is evident that, thanks to the presence of the coupling/decoupling device of the motor (M) to the generator (G), the latter does not act as a brake.

In other words the generator (G) performs its function without negatively affecting the performances and the efficiency of the motor (M).

Further embodiments of the system are shown in the figures from 3 to 5.

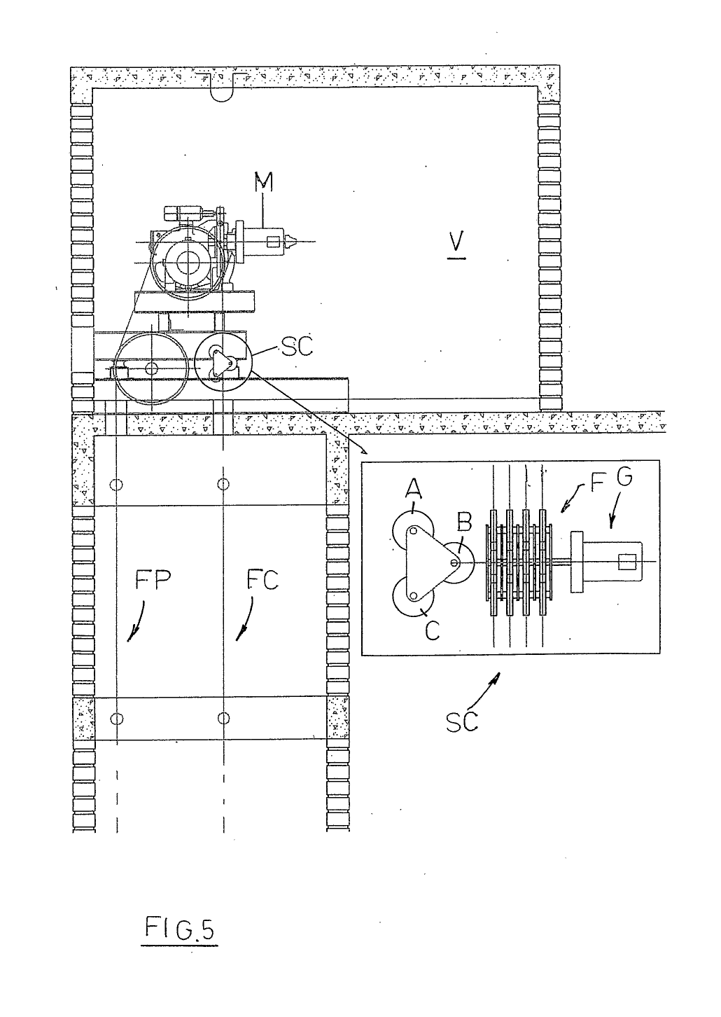

With reference to the diagram of FIG. 3, the generator (G) is coupled to the motor (M) by means of timing belt pulleys (P). In this diagram, like in those of FIGS. 4 and 5, the references “FP” and “FC” indicate the ropes of the counter-load and respectively of the cabin.

With reference to the diagram of FIG. 4, the group comprising the motor (M) and the generator (G) rests on load cells (CC) and the generator (G) is connected to the reducer (R) by means of a belt transmission. In this case, the use of an electric clutch is not foreseen and the generator (G) is activated or deactivated by acting on its excitation circuits.

With reference to the diagram of FIG. 5, the electric clutch (F) is connected to cabin ropes (FC) by means of a group formed by four terns of pulleys (four terns because the ropes (FC) are in a number of four in this embodiment) In the diagram, the pulleys mentioned above are indicated by “A”, “B” and “C”. The pulley “B” on whose axis the electric clutch is connected to the generator (G) engages with each of the pulleys “A” and “C” but the said pulleys do not engage with each other. The cabin ropes (FC) drag by contact the pulleys e “A” and “C” which, in turn, determine the rotation of the pulley “B”. This group is located in a support (SC) positioned in the motor room (V) and mounted on a frame with vertical and horizontal dampers (that is to say acting perpendicularly to the ropes) to avoid hindering the oscillations typical of ropes in operation.

According to the embodiment shown in FIGS. 6 and 7, the motor (M) and the generator (G) have the same shaft (6m) and the generator (G) is activated or deactivated by acting in automatic on the relevant excitation circuits (schematically indicated in the drawings with the reference “E”), such that the generator (G) is activated only when there is the positive work of the gravity. In practice, in this case the generator (G) is activated only when the motor (M) does not adsorb energy.

With reference to the scheme of FIG. 6, the references “FP” and “FC” denote the ropes of the counter-load and respectively of the cabin, while the reference “FR” denotes an electromagnetic brake mounted on the shaft (6m) that can be used to brake the loads when needed.

The unit formed by the motor (M) and the generator (G) with their common shaft (6m) is inside a single containing structure (SC) that simplifies the installation and maintenance operations since it contains both the motor (M) and the generator (G).

In FIG. 7 the references “SM” and “SG” denote the stator of the motor (M) and that of the generator (G), respectively, while the references “RM” and “RG” denote the rotor of the motor (M) and that of the generator (G), respectively.

The generators outputs can be destined to supply any other kind of electric appliance instead of batteries.

All the construction details may vary in any equivalent way as far as the shape, dimensions, disposition of elements, nature of the used material is concerned, without nevertheless departing from the scope of the adopted solution idea and thereby remaining within the limits of the protection granted to the present patent.

1. A system for recovering energy in apparatuses for the handling of loads, wherein a load is moved vertically by an electric motor means which, depending on an operative state thereof, adsorbs electric energy whose level is less or more than a preset value, the system comprising:
a sensing means for sensing a quantity of electric energy instant-by-instant adsorbed by said electric motor means; and
at least one electric generator for converting rotation of an output shaft of said electric motor means into electric energy, said sensing means driving activation of said at least one electric generator when the electric energy adsorbed by said electric motor means is less than a preset value and said sensing means driving the deactivation of said at least one electric generator when the electric energy adsorbed by said electric motor means is greater than said preset value.

2. A system according to claim 1, further comprising:
a connecting means positioned and acting between said electric motor means and said at least one electric generator such that said connecting means connects a shaft of the at least one electric generator with said output shaft, and said sensing means driving said connecting means in order to connect said shaft of said at least one electric generator and said output shaft to each other when the electric energy adsorbed by said electric motor means is less than said preset value and to disconnect said shaft of said at least one electric generator and said output shaft from each other when the electric energy adsorbed by said electric motor means is less than said preset value.

3. A system according to claim 1, wherein said load is connected to a first end of a cable which is connected, on an opposite end, with a counter-load, and is vertically moved by said electric motor means though a pulley or another element for moving the cable.

4. A system according to claim 1, further comprising a change-pole switch connected with said at least one electric generator.

5. A system according to claim 1, further comprising a preset amount of batteries connected with an electric output of said at least one electric generator.

6. A system according to claim 1, further comprising another electric generator, said at least one electric generator and said another electric generator being connected with two respective shafts of the electric motor means by two corresponding connecting means.

7. A system according to claim 2, wherein said connecting means is an electric clutch.

8. A system according to claim 1, wherein said sensing means senses electric current adsorbed by the electric motor means.

9. A system according to claim 1, wherein rotors of the electric motor means and of the at least one electric generator are mounted on the same shaft.

10. A system according to claim 1, wherein the electric motor means and the at least one electric generator with a common shaft are inside a single containing structure.
